(19) United States
(12) Patent Application Publication
(10) Pub. No.: US 2004/0150588 A1
(43) Pub. Date: Aug. 5, 2004

(54) Plasma display panel and gray display method thereof

(75) Inventors: Kyoung-Ho Kang, Suwon-city (KR); Seung-Hun Chae, Suwon-city (KR)

Correspondence Address: McGuireWoods LLP, Suite 1800, 1750 Tysons Boulevard, McLean, VA, 22102, US

(73) Assignee: Samsung SDI Co., Ltd.

(21) Appl. No.: 10/747,272

(22) Filed: Dec. 30, 2003

(30) Foreign Application Priority Data
Jan. 15, 2003 (KR) 2003-0002676

(51) Int. Cl. G09G 3/28

(52) U.S. Cl. 345/63

(57) ABSTRACT

A PDP including a controller for dividing one frame into subfields. The controller applying a control signal to control the number of subfields and the number of sustain pulses allocated to the subfields. The controller also has an average level sensor measuring an ASL of an input image signal of a first bit, an inverse gamma corrector correcting the image signal of the first bit into a second bit, and an image characteristic determiner for determining an image signal of a third bit in the image signal of the second bit as a gray display bit. The image characteristic determiner, decreasing the gray display bit with an increase in the ASL, and increasing the gray display bit with a decrease in the ASL. The controller also has a subfield processor for determining the number of subfields and the number of sustain pulses.

### CROSS REFERENCE TO RELATED APPLICATION

This application claims priority to and the benefit of Korean Patent Application No. 2003-2676 filed on Jan. 15, 2003 in the Korean Intellectual Property Office, the content of which is incorporated herein by reference in its entirety.

### BACKGROUND OF THE INVENTION

(a) Field of the Invention

The invention relates to a plasma display panel (PDP). More particularly, the invention relates to a gray display method in the PDP.

(b) Description of the Related Art

Flat panel displays such as a liquid crystal display (LCD), a field emission display (FED), a PDP, and the like have been actively developed. The PDP is advantageous over the other flat panel displays in regard to its high luminance, high luminous efficiency, and wide viewing angle. For at least these reasons, PDPs have been preferred over the conventional cathode ray tube (CRT) for making large-scale screens of 40 inches or more.

PDPs are flat panel displays that use plasma generated by gas discharge to display characters or images, and it includes, depending on its size, more than several scores to millions of pixels arranged in a matrix pattern. Such PDPs may be classified as direct current (DC) type and an alternating current (AC) type according to the PDPs' discharge cell structure and the waveform of the driving voltage applied thereto.

DC PDPs have electrodes exposed to a discharge space to allow a DC to flow through the discharge space while the voltage is applied, and thus a resistance for limiting the current should be provided. Contrarily, AC PDPs have electrodes covered with a dielectric layer forming a capacitance component to limit the current and protect the electrodes from the impact of ions during a discharge. Thus, AC PDPs generally have a longer lifetime than DC PDPs.

FIG. 1 is a partial perspective view of an AC PDP.

Referring to FIG. 1, pairs of scan and sustain electrodes 4 and 5 and a protective layer 3 are arranged in parallel on a glass substrate 1. The scan and sustain electrodes 4 and 5 are covered with a dielectric layer 2. A plurality of address electrodes 8, which are covered with an insulating layer 7 are arranged on a second glass substrate 6. Partition walls 9 are formed in parallel with the address electrodes 8 on the insulating layer 7, and are arranged between the address electrodes 8. Phosphors 10 are formed on the surface of the insulating layer 7 and on both sides of the partition walls 9. The glass substrates 1 and 2 are arranged in a face-to-face relationship with a discharge space 11 formed therebetween. The scan and sustain electrodes 4 and 5 lie in a direction perpendicular to the address electrodes 8. Discharge spaces at the intersections between the address electrodes 8 and the pairs of scan electrode 4 and sustain electrode 5 form discharge cells 12.

FIG. 2 shows an arrangement of the electrodes in the PDP.

Referring to FIG. 2, the PDP has a pixel matrix consisting of m×n discharge cells. More specifically, address electrodes A₁ to Aₘ are arranged in m columns, and scan electrodes Y₁ to Yₙ and sustain electrodes X₁ to Xₙ are alternately arranged in n rows. Discharge cells 12, shown in FIG. 2, correspond to the discharge cells 12 of FIG. 1.

Typically, the driving method of the AC type PDP comprises a reset period, an addressing period, and a sustain period in temporal sequence.

During the reset period, the state of each cell is initialized to facilitate the addressing operation on the cell. During the addressing period, wall charges are accumulated on selected cells (i.e., addressed cells) that are turned on in the panel. During the sustain period, a discharge occurs to actually display an image on the addressed cells.

Generally, in PDPs, as illustrated in FIG. 3, one frame (i.e., one TV field) is divided into a plurality of subfields, which are subjected to time division control for gray display. Each subfield is generally comprised of a reset period, an addressing period, and a sustain period, as described above. FIG. 3 shows one frame divided into eight subfields to display 256 gray levels, each subfield being comprised of a reset period (not shown), an address period (A1 to A8), and a sustain period (S1 to S8). During the sustain period (S1 to S8), the ratio of the luminous periods (1T, 2T, 4T, . . . , 128T) is 1:2:4:8:16:32:64:128.

To produce 3 gray levels, for example, the luminous periods SF1 and SF2 are used and the sum of the discharge periods is 3T (i.e., 1T for the luminous period of the subfield SF1 plus 2T for the luminous period of the subfield SF2). In this manner, a 256-gray image can be displayed with a combination of the subfields. Each subfield has a different luminous period. To implement 12-bit gray in this driving method, the lower four bits are represented by error diffusion or a dithering technique.

The use of error diffusion or a dithering technique allows representation of a gray corresponding to the lower bits, which are otherwise impossible to represent, but this has a limitation in the minimum quantity of light. Due to the limited minimum quantity of light represented by the subfield corresponding to the least significant bit, the error diffusion or dithering technique has a limitation in substantially increasing the gray display range and therefore requires an increase in the gray display bit. But, for the elimination of contour noise, the sustain weight among the subfields must be reduced, thereby requiring a reduced gray display bit.

### SUMMARY OF THE INVENTION

The invention provides a gray display method for a PDP that enhances the low-gray representation ability and reduces the contour noise.

The invention controls the gray display bit according to the image to be displayed.

The invention provides a plasma display panel that includes first and second electrodes formed in parallel on a first substrate, an address electrode intersecting the first and second electrodes and formed on a second substrate, a driver, and a controller. The driver applies sustain pulses necessary for driving the first and second electrodes. The controller divides one frame into a plurality of subfields, and applies a control signal to control the number of subfields constituting one frame and the number of sustain pulses allocated to each subfield. The controller includes a brightness sensor, an inverse gamma corrector, an image characteristic determiner, and a subfield processor.

In various embodiments of the invention, the brightness sensor senses a brightness level of an input image signal of a first bit. The inverse gamma corrector corrects the image signal of the first bit into an image signal of a second bit. The second bit is generally greater than the first bit. The image characteristic determiner determines an image signal of an upper third bit in the image signal of the second bit as a gray display bit, decreases the gray display bit with an increase in the brightness level, and increases the gray display bit with a decrease in the brightness level. The subfield processor determines the number of subfields and the number of sustain pulses for displaying one frame according to the gray display bit determined by the image characteristic determiner.

In various embodiments of the invention, the controller further includes an error diffuser for error-diffusing the lower bits other than the gray display bit in the image signal of the second bit.

In various embodiments of the invention, the controller further includes a sustain determiner for commanding the subfield processor to control the number of sustain pulses allocated to each subfield according to the brightness level. The sustain determiner controls the number of sustain pulses in inverse proportion to the brightness level.

In various embodiments of the invention, the brightness sensor is an average level sensor for calculating an average signal level (ASL) as an average of the image signal values input for one frame to sense the brightness level. Preferably, the controller further includes a vertical sync frequency detector for detecting an externally input vertical sync frequency and sending information necessary for the image characteristic determiner in determining the gray display bit.

In various embodiments of the invention, the inverse gamma corrector further includes a lookup table for storing the image signal of the second bit corresponding to the image signal of the first bit.

In another aspect of the invention, there is provided a gray display method for a plasma display panel, which is for dividing one frame into a plurality of subfields to display grays in a plasma display panel that includes first and second electrodes formed in parallel on a first substrate, and an address electrode intersecting the first and second electrodes and formed on a second substrate. The gray display method includes inverse-gamma-correcting an externally input image signal of a first bit into an image signal of a second bit, measuring a brightness level of the image signal, selecting an upper third bit in the image of the second bit as a gray display bit according to the brightness level, and determining the number of subfields for displaying one frame according to the gray display bit. The third bit is decreased with an increase in the brightness level, and increased with a decrease in the brightness level. Then, the number of subfields for displaying one frame is determined according to the gray display bit.

### BRIEF DESCRIPTION OF THE DRAWINGS

The accompanying drawings, which are incorporated in and constitute a part of the specification, illustrate an exemplary embodiment of the invention, and, together with the description, serve to explain the principles of the invention.

FIG. 1 is a partial perspective view of a conventional AC PDP.

FIG. 2 shows an arrangement of electrodes in the PDP.

FIG. 3 shows a exemplary frame of the PDP.

FIG. 4 is a schematic plan diagram of a PDP according to an exemplary embodiment of the invention.

FIG. 5 is a schematic block diagram of a controller in the PDP according to the exemplary embodiment of the invention.

FIG. 6 shows an inverse gamma correction curve of the PDP according to the exemplary embodiment of the invention.

FIG. 7 shows the gray display bit determined by the controller according to the exemplary embodiment of the invention.

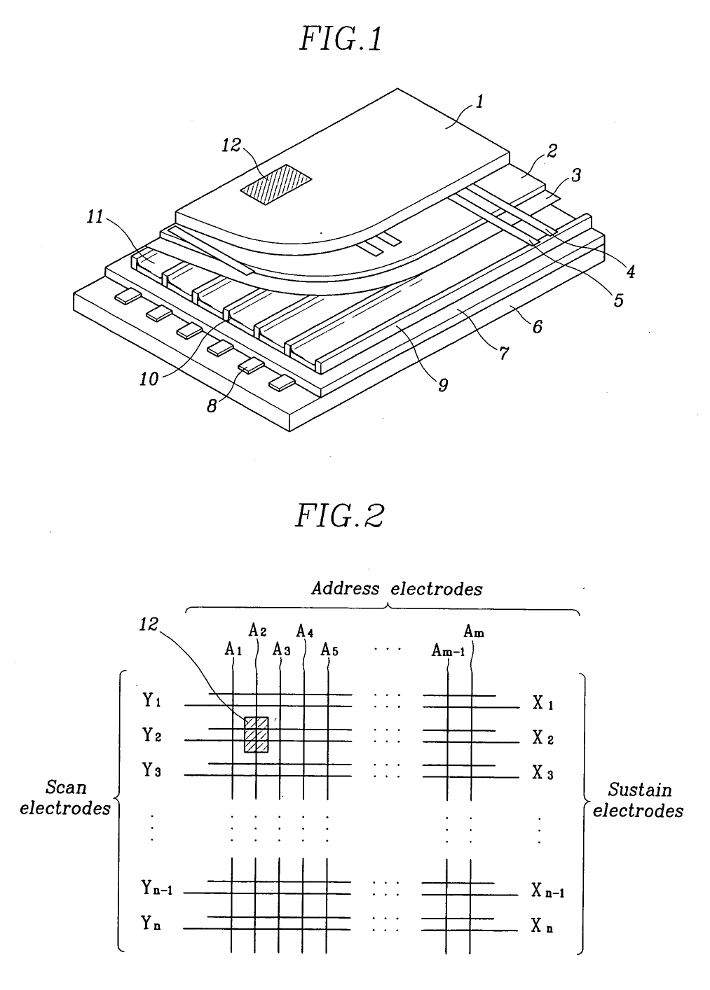

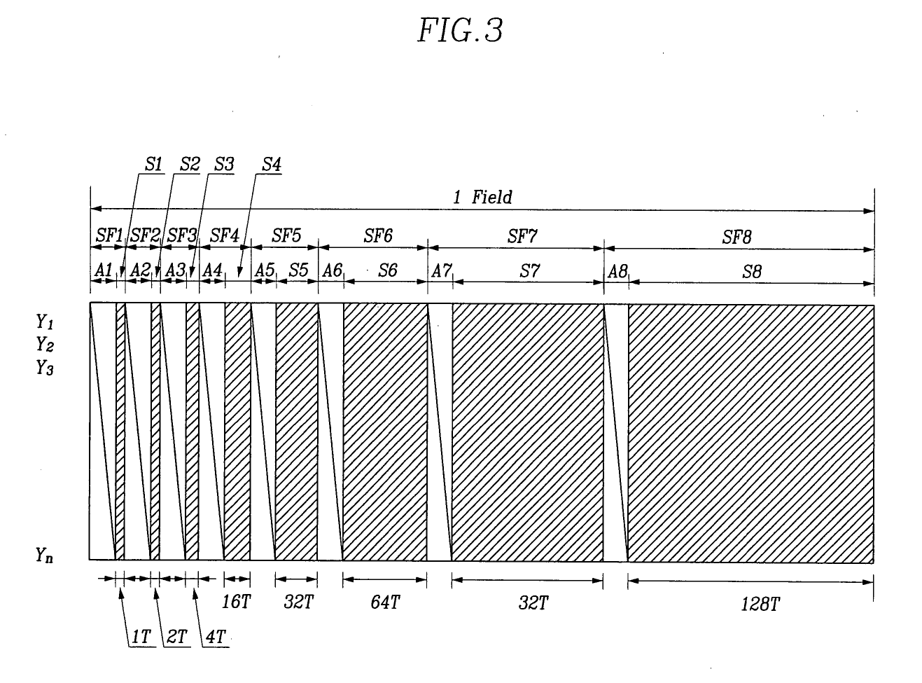

### DETAILED DESCRIPTION OF THE EXEMPLARY EMBODIMENTS

In the following detailed description, only exemplary embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. For an evident description of the invention, the parts not related to the description are omitted in the illustrations. The same reference numerals are assigned to the same parts all through the specification.

Hereinafter, a PDP and a gray display method thereof will be described in detail with reference to the accompanying drawings.

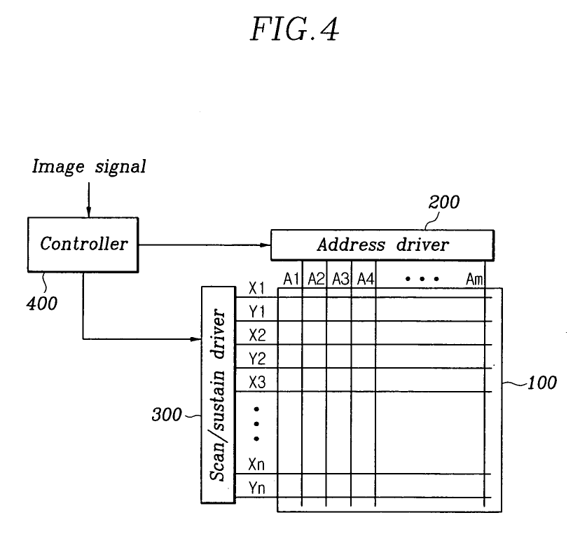

FIG. 4 is a schematic plan diagram of a PDP according to an exemplary embodiment of the invention.

The PDP according to the exemplary embodiment of the invention comprises, as shown in FIG. 4, a plasma panel 100, an address driver 200, a scan/sustain driver 300, and a controller 400.

The plasma panel 100 comprises a plurality of address electrodes A₁ to Aₘ arranged in columns, and a plurality of scan electrodes Y₁ to Yₙ and sustain electrodes X₁ to Xₙ alternately arranged in rows. The address driver 200 receives an address drive control signal from the controller 400, and applies a display data signal for selection of discharge cells to be displayed, to the individual address electrodes A₁ to Aₘ. The scan/sustain driver 300 receives a control signal from the controller 400, and applies a sustain voltage alternately to the scan electrodes Y₁ to Yₙ and the sustain electrodes X₁ to Xₙ to cause sustain-discharging on the selected discharge cells.

The controller 400 externally receives RGB image signals and sync signals to divide one frame into a plurality of subfields and drives the PDP. Each subfield is divided into at least a reset period, an address period, and a sustain period. The controller 400 controls the number of sustain pulses included during each sustain period of the subfields in one frame, and supplies control signals to the address driver 200 and the scan/sustain driver 300.

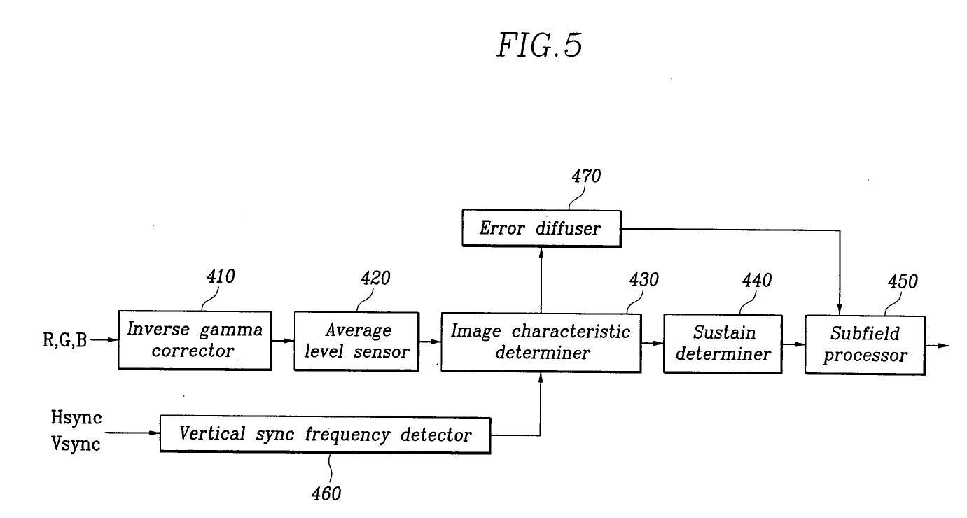

Next, the controller 400 according to the exemplary embodiment of the invention will be described in detail with reference to FIGS. 5, 6, and 7.

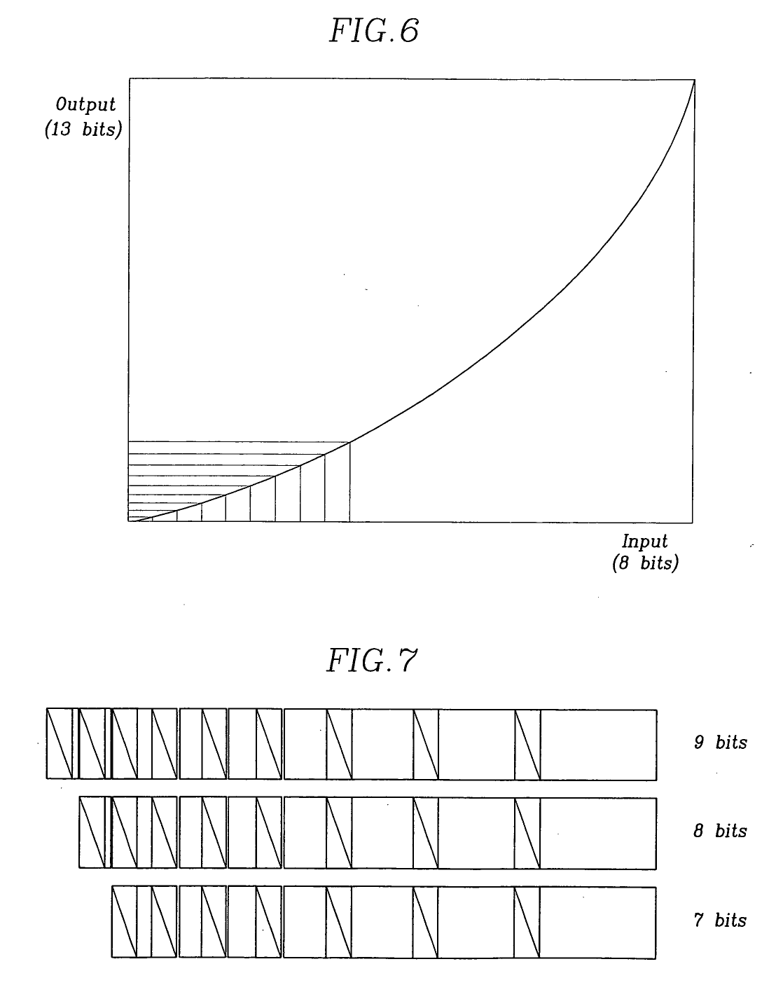

FIG. 5 is a schematic block diagram of a controller in a PDP according to an exemplary embodiment of the invention. FIG. 6 shows an inverse gamma correction curve of the PDP according to the exemplary embodiment of the invention. FIG. 7 shows the gray display bit determined by the controller according to the exemplary embodiment of the invention.

The controller of the PDP comprises, as shown in FIG. 5, an inverse gamma corrector 410, an average level sensor 420, an image characteristic determiner 430, a sustain determiner 440, a subfield processor 450, a vertical sync frequency detector 460, and an error diffuser 470.

The inverse gamma corrector 410 maps input n-bit RGB image signals to an inverse gamma curve and corrects them into m-bit (m≧n) image signals. Generally, in a PDP, n is equal to 8; and m is equal to 10 or 12. In the example of FIG. 6, the input image signal is an 8-bit signal that is displayed with 256 linear gray levels (0, 1, 2, . . . , 255). The input image signal is subjected to inverse gamma correction at the inverse gamma corrector 410 into a 13-bit image signal having 256 non-linear gray levels. This process enhances the low-gray representation ability. In the embodiment of the invention, the image of the lower four bits other than the gray display bit N determined by the image characteristic determiner 430 is processed at the error diffuser 470 by error diffusion.

The image signal fed into the inverse gamma corrector 410 is a digital signal. So, analog image signals fed into the PDP must be converted to digital image signals through an analog-to-digital converter (not shown). The inverse gamma corrector 410 may comprise a lookup table (not shown) storing data corresponding to the inverse gamma curve for mapping the image signal, or a logic circuit (not shown) for generating data corresponding to the inverse gamma curve through a logic operation.

The average level sensor 420 measures the average signal level (ASL) of the inverse-gamma-corrected image signal. The ASL is measured as the value of RGB image signals input for one frame. Namely, the ASL is obtained by dividing the total sum of the input RGB signal values for one frame by the number of the input image signals. A high ASL means that the image is bright, and a low ASL means that the image is dark.

$$ASL = ( {\sum }_{V} {RDATA}_{n} + {\sum }_{V} {GDATA}_{n} + {\sum }_{V} {BDATA}_{n} ) / 3 N \qquad [ Equation 1 ]$$

where RDATAₙ, GDATAₙ, and BDATAₙ are R, G, and B image signal values, respectively; V is one frame; and 3N is the number of input RGB image data signals for one frame.

The vertical sync frequency detector 460 detects a vertical sync frequency from externally input vertical sync signals Vsync. The vertical sync frequency is generally about 60 Hz (NTSC) or 50 Hz (PAL) for general image signals, but higher than the standard frequency (60 or 50 Hz) for input image signals generated from computers or the like. For the input image signals of such a high frequency, the time allocated to one frame is short and the number of subfields used for one frame must be reduced. Thus, upon detecting a vertical sync frequency higher than the standard frequency, the vertical sync frequency detector 460 sends a signal representing the detection of the high vertical sync frequency to the image characteristic determiner 430.

The image characteristic determiner 430 analyzes the brightness of the image according to the average signal level (ASL) and the vertical sync frequency to determine the gray display bit N. In the invention, the gray display bit N is less than the number of bits of the inverse-gamma-corrected image signal (1≦N≦m). With a high ASL value, at which the image of high gray levels is mainly displayed, there is no need for increasing the low-gray representation ability, and the image characteristic determiner 430 determines the gray display bit N as a low value. Contrarily, with a low ASL value, at which the image of low gray levels is mainly displayed, the low-gray representation ability should be enhanced. Thus, the image characteristic determiner 430 determines the gray display bit N as a high value.

With a low ASL based on the eight bits, other than the four bits processed by error diffusion among twelve bits, for example, the image characteristic determiner 430 processes the gray display bit N as 9 bits. But, with a high ASL, the image characteristic determiner 430 processes the gray display bit N as 7 bits. Namely, in the case of 7-bit gray processing, the error diffuser 470 processes the four bits lower than the 7 bits by error diffusion and discards the 2 least significant bits. For 8-bit gray processing, the error diffuser 470 processes the four bits lower than the 8 bits by error diffusion and discards the least significant bit.

Referring to FIG. 7, the number of lower bits in the 7-bit gray processing table is less than the number of grays in the 8-bit gray processing table by one, so the representation of low gray levels is coarse but the display is bright. The human eyes almost cannot recognize this effect. The 8-bit gray processing may eliminate contour noise that possibly occurs when the image has a change from 127 grays (011111112) to 128 grays (100000002). The number of lower bits in the 9-bit gray processing table is more than that in the 8-bit gray processing table by one, so precise low-gray representation can be achieved.

The sustain determiner 440 determines the weight of the number of sustain pulses used for each subfield according to the ASL, and sends the determined weight to the subfield processor 450. With a high ASL, at which a bright image is represented, the sustain determiner 440 decreases the weight of the number of sustain pluses allocated to one subfield so as to reduce power consumption. Contrarily, with a low ASL, at which a dark image is represented, the sustain determiner 440 increases the weight of the number of sustain pulses allocated to one subfield.

In this manner, the unit quantity of light from the least significant bit for the 7-bit gray processing table becomes almost equal to that from the least significant bit for the 9-bit gray processing table. More specifically, as shown in FIG. 7, the size of the least significant bit increases by the multiples but the number of sustain pulses decreases with an increase in the ASL value. So, the quantity of light from the least significant bit can be substantially constant irrespective of the ASL.

The error diffuser 470 displays the image of the lower 4 bits other than the gray display bit N determined by the image characteristic determiner 430 by error diffusion or a dithering technique. The error diffusion, which is a method for displaying an image for the lower 4 bits by isolating the image for the lower 4 bits and diffusing it to the adjacent pixels, is disclosed in Korean Patent Publication No. 2002-0014766.

The subfield processor 450 determines the number of subfields actually driven for one frame and the number of sustain pulses for each subfield according to the gray display bit N determined by the image characteristic determiner 430, the weight of the number of sustain pulses determined by the sustain determiner 440, and the error diffusion determined by the error diffuser 470. The subfield processor 450 sends information about the number of subfields and the number of sustain pulses to the scan/sustain driver 300. Based on the information, the scan/sustain driver 300 generates sustain pulses and applies them to the scan electrodes Y₁ to Yₙ and sustain electrodes X₁ to Xₙ to cause a discharge of the discharge cells and to display an image of a desired gray.

The average level sensor 420 senses the ASL to measure the brightness in the embodiment of the invention. But, the brightness can also be measured, for example, from peak level, power consumption, image movement, contrast, or a combination of these characteristics, in addition to the ASL.

As described above, the invention increases the gray display bit for a dark image to enhance the low-gray representation ability and decreases the gray display bit for a bright image, in which case the low-gray representation ability is not significant, thereby reducing contour noise.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A plasma display panel comprising:
a plasma panel including a first electrode and a second electrode and an address electrode, the first electrode and the second electrode being substantially parallel to each other on a first substrate and the address electrode intersecting the first electrode and the second electrode and being formed on a second substrate;
a driver for applying sustain pulses for driving the first electrode and the second electrode; and
a controller for dividing one frame into a plurality of subfields, and applying a control signal to control the number of subfields constituting one frame and a number of sustain pulses allocated to each subfield,
the controller comprising:
a brightness sensor for sensing a brightness level of an input image signal of a first bit;
an inverse gamma corrector for correcting the image signal of the first bit into an image signal of a second bit, the second bit being greater than the first bit;
an image characteristic determiner for determining an image signal of an upper third bit in the image signal of the second bit as a gray display bit, decreasing the gray display bit with an increase in the brightness level, and increasing the gray display bit with a decrease in the brightness level; and
a subfield processor for determining the number of subfields and the number of sustain pulses for displaying one frame according to the gray display bit determined by the image characteristic determiner.

2. The plasma display panel as claimed in claim 1, wherein the controller further comprises:
an error diffuser for error-diffusing the lower bits other than the gray display bit in the image signal of the second bit.

3. The plasma display panel as claimed in claim 1, wherein the controller further comprises:
a sustain determiner for commanding the subfield processor to control the number of sustain pulses allocated to each subfield according to the brightness level.

4. The plasma display panel as claimed in claim 3, wherein the sustain determiner controls the number of sustain pulses in inverse proportion to the brightness level.

5. The plasma display panel as claimed in claim 1, wherein the brightness sensor includes an average level sensor for calculating an average signal level as an average of the image signal values input for one frame to sense the brightness level.

6. The plasma display panel as claimed in claim 1, wherein the controller further comprises:
a vertical sync frequency detector for detecting an externally input vertical sync frequency and sending information necessary for the image characteristic determiner in determining the gray display bit.

7. The plasma display panel as claimed in claim 1, wherein the inverse gamma corrector further comprises:
a lookup table for storing the image signal of the second bit corresponding to the image signal of the first bit.

8. A gray display method for a plasma display panel, which is for dividing one frame into a plurality of subfields to display grays in a plasma display panel that includes first electrodes and second electrodes formed in parallel on a first substrate, and an address electrode intersecting the first and second electrodes and formed on a second substrate, the gray display method comprising:
inverse-gamma-correcting an externally input image signal of a first bit into an image signal of a second bit;
measuring a brightness level of the image signal;
selecting an upper third bit in the image of the second bit as a gray display bit according to the brightness level; and
determining the number of subfields for displaying one frame according to the gray display bit,
wherein the selecting step comprising decreasing the third bit with an increase in the brightness level and increasing the third bit with a decrease in the brightness level.

9. The gray display method as claimed in claim 8, wherein the determining step further comprises determining the number of sustain pulses allocated to each subfield in inverse proportion to the brightness level.

10. The gray display method as claimed in claim 8, wherein the determining step further comprises error-diffusing an image signal of a lower fourth bit of the upper third bit in the image signal of the second bit.

11. The gray display method as claimed in claim 8, wherein the selecting step further comprises detecting an externally input vertical sync frequency to determine the gray display bit according to the vertical sync frequency.

12. The gray display method as claimed in claim 8, wherein the measuring step comprises calculating an average signal level as an average of the image signal values input for one frame to determine the brightness level.

13. The gray display method as claimed in claim 8, wherein the inverse-gamma-correcting step comprises correcting the image signal of the first bit into the image signal of the second bit by using a lookup table storing the image signal value of the second bit corresponding to the image signal of the first bit.
